(19) United States
(12) Patent Application Publication
(10) Pub. No.: US 2023/0256496 A1
(43) Pub. Date: Aug. 17, 2023

(54) TRAPPED PARTS VIA SWAGING

(71) Applicant: METAL FORMING & COINING CORPORATION, Maumee, OH (US)

(72) Inventors: Timothy John Cripsey, Rochester, MI (US); Robert Herston, New Baltimore, MI (US); Nicholas Brockett, Warren, MI (US)

(21) Appl. No.: 18/171,112

(22) Filed: Feb. 17, 2023

Related U.S. Application Data
(60) Provisional application No. 63/268,133, filed on Feb. 17, 2022.

(51) Int. Cl. B21D 39/04

(52) U.S. Cl. CPC B21D 39/046

(57) ABSTRACT

A method of operating a swaging station includes removably coupling an insert to a distal end of a mandrel and advancing the insert and the distal end of the mandrel into a hollow interior of a tubular body defined by an inner circumferential surface thereof. A die of the swaging station is utilized to deform the tubular body radially inwardly to cause the inner circumferential surface of the tubular body to contact the insert to capture the insert within the tubular body at a desired axial position. The mandrel and die are retracted to result in a tubular component having an integrated insert disposed therein.

### CROSS-REFERENCE TO RELATED APPLICATIONS

This patent application claims priority to U.S. Provisional Patent Application Ser. No. 63/268,133 filed on Feb. 17, 2022, the entire disclosure of which is hereby incorporated herein by reference.

### FIELD OF THE INVENTION

The present invention relates generally to a metal forming process for forming a tubular component, and more particularly, to a swaging process for capturing an insert within a hollow interior of a surrounding tubular component.

### BACKGROUND OF THE INVENTION

Swaging generally refers to a forging process wherein a configuration of a workpiece is altered via the application of force using one or more dies. One swaging process that may be performed with respect to a tubular or cylindrical structure includes the use of a mandrel that is received within a hollow interior of the tubular or cylindrical structure. The mandrel is configured to delimit the radial inward deformation of the tubular or cylindrical structure to form a central bore through the resulting swaged part when the mandrel is removed therefrom, wherein a configuration of the central bore is defined by the outer surface of the mandrel where the tubular or cylindrical structure is deformed radially inwardly by the corresponding swaging process. In another process, the tubular or cylindrical structure is deformed radially inwardly (necked) absent the inclusion of such a mandrel, while still resulting in the formation of a central void in the resulting swaged part.

One disadvantage of such swaging processes relates to the need for additional joining steps when it is necessary to incorporate another component within the hollow void formed within the swaged part. For example, in some circumstances it may be necessary to plug an end of the hollow void, or to incorporate or join a secondary component to the swaged part via a mechanical interaction with the interior surface of the swaged part defining the hollow void. This may require an additional welding step or similar aggressive joining process to complete the part, which may add tooling, time, and steps, and in some circumstances the need for additional joining components and further processes.

It is accordingly desirable to provide a method of swaging a tubular or cylindrical component to include a secondary component captured therein during the corresponding swaging process.

### SUMMARY OF THE INVENTION

Concordant and congruous with the present invention, a method of manufacturing a swaged part having an secondary component captured therein during a swaging process has surprisingly been discovered.

According to an embodiment of the present invention, a swaged tubular component includes an axially extending tubular body having an inner circumferential surface defining a hollow interior thereof and an oppositely arranged outer circumferential surface, and an insert immovably coupled to the inner circumferential surface of the tubular body during a swaging process wherein the tubular body is deformed radially inwardly to contact the insert when the insert is received within the hollow interior of the tubular body.

According to another embodiment of the present invention, a swaging station includes a mandrel configured to selectively advance into a hollow interior of a tubular body defined by an inner circumferential surface thereof, wherein the mandrel is configured to be removably coupled to an insert, and a die configured to deform an outer circumferential surface of the tubular body radially inwardly when the insert is disposed within the hollow interior of the tubular body during the selective advancement of the mandrel therein, wherein the deforming of the outer circumferential surface radially inwardly causes the inner circumferential surface of tubular body to contact the insert to capture the insert within the tubular body.

A method of manufacturing a tubular component is also disclosed and includes the steps of removably coupling an insert to a distal end of a mandrel, advancing the insert and the distal end of the mandrel into a hollow interior of a tubular body defined by an inner circumferential surface thereof, and deforming the tubular body radially inwardly using a die to cause the inner circumferential surface of the tubular body to contact the insert to capture the insert within the tubular body.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings.

FIG. 1 is an elevational cross-sectional view of a swaging station having a mandrel removably coupled to an insert to be captured within a swaged tubular member according to an embodiment of the present invention;

FIG. 2 is an elevational cross-sectional view of the swaging station of FIG. 1 showing the mandrel and insert advanced into a hollow interior of a tubular member;

FIG. 3 is an elevational cross-sectional view of the swaging station of FIG. 1 showing a die deforming an outer surface of the tubular member to capture the insert; and

FIG. 4 is an elevational cross-sectional view of the swaging station of FIG. 1 showing the die and the mandrel as retracted to result in a swaged part having a captured insert.

### DETAILED DESCRIPTION OF EXEMPLARY EMBODIMENTS OF THE INVENTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

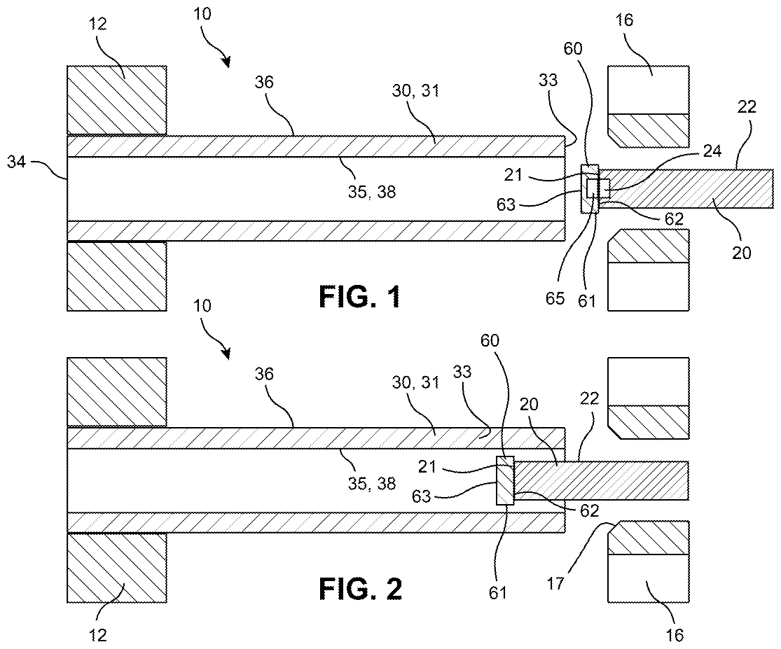

FIGS. 1-4 illustrate a swaging station 10 and a method of use thereof according to an embodiment of the present invention. The swaging station 10 is configured to perform a swaging process for capturing an insert 60 within a tubular (cylindrical or axially symmetric) body 30 for forming a tubular component 80 having an integrated insert 60 immovably captured therein. The swaging station 10 may include a clamping mechanism 12, a die 16, and a mandrel 20, depending on the circumstances.

The tubular body 30 is hollow and includes a circumferential wall 31 extending axially from a first end 33 to an opposing second end 34 thereof. The circumferential wall 31 includes an inner circumferential surface 35 and an oppositely arranged outer circumferential surface 36. The illustrated tubular body 30 is shown as being open at each opposing end 33, 34 thereof. However, the tubular body 30 need only be open at the first end 33 thereof for carrying out the method according to the present invention, hence a hollow interior 38 of the tubular body 30 as defined by the inner circumferential surface 35 thereof need only extend to and intersect the first end 33 of the circumferential wall 31. The hollow interior 38 must also extend axially into the tubular body 30 a sufficient distance to result in advancement of the insert 60 therein to the desired axial position for capturing the insert 60 within the tubular body 30.

The tubular body 30 is shown as being purely cylindrical in shape, but it should be understood that alternative tubular or axially symmetric configurations may be utilized while remaining within the scope of the present invention, so long as each of the circumferential surfaces 35, 36 and the hollow interior 38 of the tubular body 30 are configured for use with the swaging station 10 in the manner described herein. For example, the tubular body 30 may already be preformed to include a varying axially symmetric tubular configuration during a previous forming step while still maintaining the necessary configuration of the circumferential surfaces 35, 36 at the first end 33 of the tubular body 30 in a manner allowing for access of the mandrel 20 and a deforming process using the die 16.

The clamping mechanism 12 may be configured to securely grasp the tubular body 30 during the corresponding swaging process such that the tubular body 30 is deformed relative to the clamping mechanism 12. In some embodiments, the clamping mechanism 12 may move the tubular body 30 relative to the die 16 and/or the mandrel 20 during certain steps of the disclosed method. Alternatively, in other embodiments the clamping mechanism 12 may maintain a fixed position of the tubular body 30 as the die 16 and/or mandrel 20 are moved relative thereto during certain steps of the disclosed method. It should be apparent to one skilled in the art that the same relative movements will result in the same relationships as disclosed herein, hence alternative configurations of relative movement may be utilized without necessary departing from the scope of the present invention.

The die 16 may be comprised of a single die element or may be comprised of a plurality of circumferentially divided die elements, as desired. The die 16 includes a deforming surface 17 configured to engage the outer circumferential surface 36 of the circumferential wall 31 during a swaging process configured to deform the outer circumferential surface 36 at least partially in the radial inward direction in a manner resulting in a radial inward advancement of the inner circumferential surface 35 of the circumferential wall 31 during the corresponding deformation of the circumferential wall 31. The die 16 may be representative of a number of different dies utilized in different swaging processes without necessarily departing from the scope of the present invention. The die 16 (or die elements) may be configured to advance the deforming surface 17 axially relative to the tubular body 30 to progressively deform the outer circumferential surface 36 at least partially radially inwardly in accordance with the configuration of the deforming surface 17 (or surfaces). Alternatively, the die 16 (or die elements) may be configured to advance to a position radially outwardly of the outer circumferential surface 36 prior to a radial inward force being applied to the outer circumferential surface 36 via a radial inward movement of the die 16 or one of the corresponding die elements to deform the outer circumferential surface 36 at least partially radially inwardly in accordance with the configuration of the deforming surface 17 (or surfaces).

The mandrel 20 includes a distal end 21 and an outer circumferential surface 22 extending axially from the distal end 21. The outer circumferential surface 22 is shown as being purely axial in extension, but alternative shapes of the outer circumferential surface 22 may be utilized so long as the outer circumferential surface 22 is shaped and dimensioned to be received within the hollow interior 38 of the tubular body 30 to the desired axial depth and includes a decreasing diameter towards the distal end 21 to allow for axial removal of the mandrel 20 from the completed tubular component 80.

The distal end 21 of the mandrel 20 includes a first coupling element 24 (shown schematically in FIG. 1) configured to removably couple the distal end 21 of the mandrel 20 to the insert 60. The insert 60 includes an outer circumferential surface 61 extending axially to each of a first end face 62 of the insert 60 configured to face towards the distal end 21 of the mandrel 20 when the insert 60 is removably coupled thereto and a second end face 63 facing away from the mandrel 20 opposite the first end face 62. The first end face 62 of the insert 60 includes a second coupling element 65 (shown schematically in FIG. 1) configured to cooperate with or otherwise mate with the disclosed first coupling element 24 of the mandrel 20 to maintain a position of the insert 60 relative to the mandrel 20 during the removable coupling therebetween, wherein the maintaining of the position is configured to occur selectively during certain steps of the method of the present invention.

In some embodiments, the first coupling element 24 is a first magnetic component and the second coupling element 65 is a second magnetic component. The first magnetic component may refer to a portion or an entirety of the distal end 21 of the mandrel 20 being formed from a magnetic material, such as a permanent magnet coupled to the distal end 21 or a mandrel 20 formed of a magnetic material. In other embodiments, the first magnetic component may refer to an electromagnetic component disposed at the distal end 21 and configured to selectively apply an electromagnetic force to attract the second magnetic component thereto. The second magnetic component may be formed by the insert 60 being formed from a magnetic material or the insert 60 being coupled to a magnetic material such as a dedicated permanent magnet. The magnetic forces present between the first magnetic component and the second magnetic component may be selectively engaged via use of the electromagnetic component to allow for the mandrel 20 to hold or release the removable coupling present between the mandrel 20 and the insert 60 at desired instances during the disclosed method. Alternatively, if a passive magnetic attraction is utilized, the magnetic forces present between first and second magnetic components may be selected to be strong enough to maintain the position of the insert 60 relative to the mandrel 20 during desired intervals while also allowing for disengagement of the insert 60 from the mandrel 20 during removal of the mandrel 20 from the tubular body 30.

In other embodiments, the first coupling element 24 and the second coupling element 65 are provided as mating or interlocking structural features that facilitate a support of the insert 60 relative to the mandrel 20 during a corresponding swaging process. As one example, one of the coupling elements 23, 24 may be one or more projections extending axially from one of the facing surfaces 21, 62 while the other of the coupling elements 23, 24 may be one or more axially extending indentations configured to receive the projection(s) therein. The projection(s) and indentation(s) may be provided to include an axially asymmetric configuration to prevent undesired rotation of the insert 60 relative to the mandrel 20.

In yet other embodiments, the coupling elements 24, 65 may be provided as a combination of magnetic and mechanical interfacing features to facilitate the proper locating and desired coupling between the insert 60 and the mandrel 20. For example, mating indentations and projections may be utilized to position paired magnetic components adjacent each other when the insert 60 is removably coupled to the mandrel 20.

The method according to the present invention may occur as follows. First, as shown in FIG. 1, the first end face 62 of the insert 60 is removably coupled to the distal end 21 of the mandrel 20 via one or more of the described interactions that may occur between the first and second coupling elements 24, 65. The tubular body 30 may be clamped by the clamping mechanism 12 to affix a position of the tubular body 30 to the clamping mechanism 12. The mandrel 20 and the insert 60 removably coupled thereto are placed in axial alignment with the hollow interior 38 of the tubular body 30. Specifically, a central axis of the insert 60 and/or the mandrel 20 may be placed in axial alignment with a central axis of the tubular body 30 also forming a central axis of the hollow interior 38.

As shown in FIG. 2, the mandrel 20 having the insert 60 removably coupled thereof is then advanced axially to position the insert 60 and the distal end 21 of the mandrel 20 axially beyond the first end 33 of the tubular body 30 at a desired axial depth within the hollow interior 38 corresponding to a desired axial position at which the insert 60 is captured within the tubular body 30. As mentioned above, all described relative movement may include the clamping mechanism 12 translating the tubular body 30 relative to the die 16 and/or the mandrel 20, may include the die 16 and/or the mandrel 20 translating relative to the fixed tubular body 30 and clamping mechanism 12, and/or combinations thereof, as desired. The advancing of the mandrel 20 and the insert 60 into the hollow interior 38 may include a radial clearance present between the outer circumferential surface 61 of the insert 60 and the inner circumferential surface 35 of the tubular body 30 to at least the desired depth of the insert 60 within the hollow interior 38. The insert 60 may also be provided to include a greater radial dimension at the outer circumferential surface 61 thereof in comparison to the outer circumferential surface 22 of the mandrel 20 to allow for the inwardly deforming tubular body 30 to engage the outer circumferential surface 61 prior to the outer circumferential surface 22 during a swaging process.

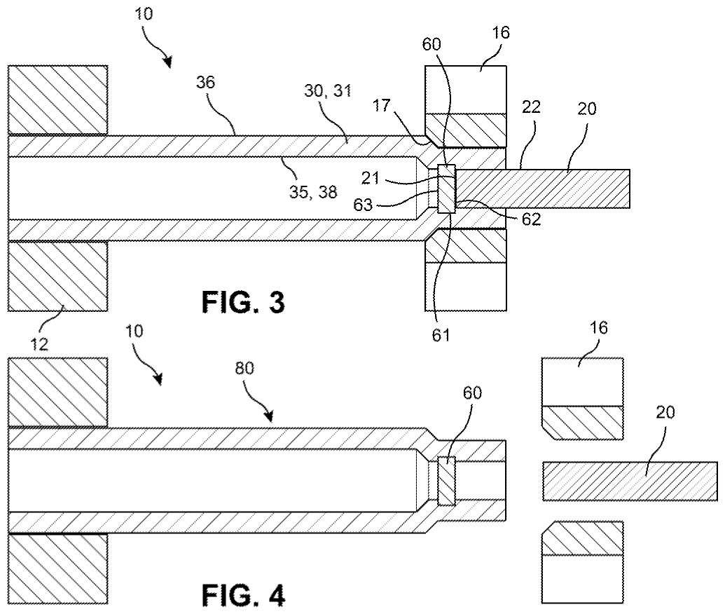

Next, as shown in FIG. 3, the die 16 is utilized to perform the desired swaging process with respect to the outer circumferential surface 36 of the tubular body 30 resulting in a portion of the tubular body 30 disposed along the inner circumferential surface 35 deforming radially inwardly towards the mandrel 20 and the insert 60 removably coupled thereto. The inward deformation of the circumferential wall 31 results in an annular segment of the inner circumferential surface 35 contacting the outer circumferential surface 61 of the insert 60 to capture the insert 60 within the tubular body 30. Additionally, the radially inward deformation may also result in the inner circumferential surface 35 deforming radially inwardly to positions radially inward of the outer circumferential surface 61 of the insert 60 at positions along or facing each of the opposing end faces 62, 63 thereof. The extension of the deformed tubular body 30 radially inwardly to face the end faces 62, 63 aids in affixing the insert 60 at the desired axial position. Although not shown, the outer circumferential surface 61 of the insert 60 may include alternative surface features, such as indentations, to allow for a portion of the deformed tubular body 30 to enter and prevent axial and/or rotational motion between the tubular body 30 and the captured insert 60. Any mechanical interaction affixing the position of the insert 60 to the tubular body 30 may be utilized while remaining within the scope of the present invention so long as the radially inwardly occurring swaging process is utilized in deforming the tubular body 30 to capture the insert 60 at the desired position.

Once the swaging process is complete, the die 16 and the mandrel 20 may be retracted to result in the formation of the tubular component 80 having the captured insert 60. The retraction of the mandrel 20 may include one of the described methods of disengaging the mating features of the first and second coupling elements 24, 65 prior to the retraction of the mandrel 20 from within the hollow interior 38, such as disengaging an electromagnetic component. It is also conceivable that a mechanical mechanism may be actuated to hold and release the insert 60 at desired intervals, as desired. In some circumstances, the mandrel 20 may axially disengage from the insert 60 during the process of retracting the mandrel 20 from the hollow interior 38, such as by removing a projection from within an indentation or by overcoming a magnetic force present between the mandrel 20 and the captured insert 60 during axial motion of the mandrel 20 away from the captured insert 60.

As shown in FIGS. 3 and 4, the swaging of the tubular body 30 may result in a tubular component 80 having a necked portion 82 where the insert 60 is captured by the deformed tubular body 30. At least a segment of the inner circumferential surface 35 of the tubular body 30 disposed between the first end face 62 of the insert 60 and the first end 33 of the tubular body 30 may be defined by the outer circumferential surface of a mandrel 22 when the mandrel 20 is utilized to delimit radial inward deformation of the tubular body 30 during the corresponding swaging process. When captured, the insert 60 may form a plug closing off the first end 33 of the hollow interior 38 of the tubular body 30. Alternatively, the insert 60 may form a secondary tubular component coupled to the tubular body 30.

The described method and apparatus allows for the creation of two-part tubular component via a single swaging manufacturing process, thereby eliminating the need for additional manufacturing steps such as aggressive joining methods for joining components to a previously swaged tubular body. The process can also be easily adapted for use with existing swaging stations via modification of the mandrel 20 and the die 16 to accommodate the described method of capturing the insert 60.

From the foregoing description, one ordinarily skilled in the art can easily ascertain the essential characteristics of this invention and, without departing from the spirit and scope thereof, can make various changes and modifications to the invention to adapt it to various usages and conditions.

We claim:

1. A swaged tubular component comprising:
an axially extending tubular body having an inner circumferential surface defining a hollow interior thereof and an oppositely arranged outer circumferential surface; and
an insert immovably coupled to the inner circumferential surface of the tubular body during a swaging process wherein the tubular body is deformed radially inwardly to contact the insert when the insert is received within the hollow interior of the tubular body.

2. The swaged tubular component of claim 1, wherein the insert forms a plug closing off an end of the hollow interior of the tubular body.

3. The swaged tubular component of claim 1, wherein the insert forms a secondary tubular component coupled to the tubular body.

4. The swaged tubular component of claim 1, wherein the insert is disposed within a necked portion of the tubular body following the swaging process.

5. The swaged tubular component of claim 1, wherein a segment of the inner circumferential surface of the tubular body disposed between the insert and an end of the tubular body is defined by an outer circumferential surface of a mandrel received within the hollow interior of the tubular body during the swaging process.

6. The swaged tubular component of claim 1, wherein the inner circumferential surface extends radially inwardly beyond an outer circumferential surface of the insert following the swaging process to affix an axial position of the insert relative to the tubular body.

7. A swaging station comprising:
a mandrel configured to selectively advance into a hollow interior of a tubular body defined by an inner circumferential surface thereof, wherein the mandrel is configured to be removably coupled to an insert; and
a die configured to deform an outer circumferential surface of the tubular body radially inwardly when the insert is disposed within the hollow interior of the tubular body during the selective advancement of the mandrel therein, wherein the deforming of the outer circumferential surface radially inwardly causes the inner circumferential surface of tubular body to contact the insert to capture the insert within the tubular body.

8. The swaging station of claim 7, wherein the mandrel includes a first coupling element and the insert includes a second coupling element, wherein the first coupling element is configured to be removably coupled to the second coupling element to selectively couple the insert to the mandrel.

9. The swaging station of claim 8, wherein the first coupling element is a first magnetic component and the second coupling element is a second magnetic component.

10. The swaging station of claim 9, wherein the first magnetic component is an electromagnetic component.

11. The swaging station of claim 9, wherein the first magnetic component is a magnetic material.

12. The swaging station of claim 8, wherein the first coupling element and the second coupling element are formed by at least one cooperating set of an indentation and a projection.

13. A method of manufacturing a tubular component comprising the steps of:
removably coupling an insert to a distal end of a mandrel;
advancing the insert and the distal end of the mandrel into a hollow interior of a tubular body defined by an inner circumferential surface thereof; and
deforming the tubular body radially inwardly using a die to cause the inner circumferential surface of the tubular body to contact the insert to capture the insert within the tubular body.

14. The method of claim 13, wherein the step of removably coupling the insert to the distal end of the mandrel includes magnetically attracting the insert to the mandrel.

15. The method of claim 13, wherein the step of removably coupling the insert to the distal end of the mandrel includes inserting a projection into a mating indentation.

16. The method of claim 13, wherein the step of deforming the tubular body radially inwardly includes the inner circumferential surface contacting an outer circumferential surface of the insert.

17. The method of claim 16, wherein the step of deforming the tubular body radially inwardly includes the inner circumferential surface contacting at least one of an pair of opposing end faces of the insert.

18. The method of claim 13, further comprising a step of decoupling the insert from the distal end of the mandrel following the step of deforming the tubular body radially inwardly using a die.

19. The method of claim 18, further comprising a step of retracting the distal end of the mandrel from the interior of the tubular body following the step of decoupling the insert from the distal end of the mandrel.

20. The method of claim 13, wherein the step of advancing the insert and the distal end of the mandrel into the hollow interior of the tubular body includes a radial clearance being present between an outer circumferential surface of the insert and the inner circumferential surface of the tubular body.
